(19) United States
(12) Patent Application Publication
(10) Pub. No.: US 2010/0155101 A1
(43) Pub. Date: Jun. 24, 2010

(54) Procedure and apparatus to bypass an energized substation switch

(76) Inventors: Lucas M. Moore, Mahomet, IL (US); Lowell Church, Kansas City, MO (US)

Correspondence Address: Antony C. Edwards, P.O. Box 26020, Westbank, BC, V4T 2G3, CA

(21) Appl. No.: 12/318,234

(22) Filed: Dec. 23, 2008

(51) Int. Cl. H02G 5/00

(52) U.S. Cl. 174/68.2

(57) ABSTRACT

An apparatus for temporarily bypassing a switch includes a pipe bus, and rigid, elongate first and second insulators mounted to the pipe bus, wherein the first and second insulators are spaced apart by a spacing greater than a corresponding dimension of the switch, and are both mounted at upper ends thereof to the bus so as to depend downwardly from the bus, and are mountable at their lower ends to a switch rack having the switch mounted thereon, where the insulators are mountable over and on opposite sides of the switch, and wherein space is provided between the switch and the bus or the insulators so that an operating portion of the switch is not obstructed by the bus or the insulators.

### FIELD OF THE INVENTION

The present invention is a procedure and associated apparatus to bypass an energized substation switch operating in the 115 kV-500 kV range.

### BACKGROUND OF THE INVENTION

Conventional wire jumper bypass methods will not work in the situation where the limits of approach would be encroached upon if the conventional wire jumper method of bypass was used. Consequently there exists a need for, and it is an object of the present invention to provide a method other than the conventional wire jumper method to place a full-current bypass across one or more phases of, for example, a 345 kV switch.

Current practice is to use wire jumpers across the length of the switch, and tie-wrap the conductor to an insulated hot line tool. This hot line tool is used to hold the jumpers rigid, and helps control the jumpers when lowered into position. The jumpers are then attached on either side of the switch to complete the electrical connection. Upon completion of this connection, the jumpers must be secured to the switch in a way that does not allow the switch to be opened.

### SUMMARY OF THE INVENTION

In summary, the apparatus for bypassing a switch according to one aspect of the present invention may be characterized as including a pipe bus, and rigid, elongate first and second insulators mounted to the pipe bus, wherein the first and second insulators are spaced apart by a first spacing, and are both mounted at upper ends thereof to the bus so as to depend downwardly from the bus. The first and second insulators are mountable at their lower ends to a switch rack having a switch mounted thereon.

The first and second insulators elevate the bus above the switch rack by a second spacing when the lower ends of the insulators are mounted to the switch rack. The first and second spacings thus define a switch receiving aperture whereby the bus and the first and second insulators are mountable over and on opposite sides of the switch respectively, and wherein the first and second spacings are sized to provide space between the switch and the bus or the insulators so that an operating portion of the switch is not obstructed by the bus or the insulators.

In one preferred embodiment the first and second insulators are a substantially parallel pair of insulators. The bus may be metallic, for example aluminium, in which case the bus may be five inches in diameter, and may by 15 feet long.

Advantageously the insulators are mounted at opposite end of the bus and are station—class polymer insulators.

The corresponding method according to the present invention for bypassing an energized switch comprises the steps of:
a) providing a pipe bus,
b) providing rigid, elongate first and second insulators and mounting the insulators to the pipe bus,
c) spacing the first and second insulators apart by a first spacing, and mounting the insulators at upper ends thereof to the bus so as to downwardly depend from the bus,
d) mounting lower ends of the insulators to a switch rack having a switch mounted thereon so as to position the switch between the insulators, and so as to elevate the bus above the switch,
e) sizing spacing between the switch and the bus and the insulators so that an operating portion of the switch is not obstructed by the bus or the insulators during operation of the switch.

The method may further include the step of aligning the insulators so that they are substantially parallel and downwardly orthogonally depending from the bus, and mounting the insulators at opposite ends of the bus.

The present invention uses five inch bus pipe with current-rated fittings and wire jumpers attached to each end. These wire jumpers are fitted to the permanent switch jumper material. This material may include wire jumpers or pipe bus. The connection to this material is made with load-rated wire or bus connectors.

### BRIEF DESCRIPTION OF THE DRAWINGS

In the accompanying of drawings where in like reference numerals denote corresponding parts in each view:

FIG. 1a is, in side elevation view, a pipe bus supported by a pair of insulators.

FIG. 1b is, in top view, the bypass apparatus of FIG. 1a.

FIG. 2 is, in shortened, inverted perspective view, one embodiment of the bypass apparatus of FIG. 1b.

FIG. 2a is an alternative embodiment of the view of FIG. 2.

FIG. 2b is, in partially exploded, partially cutaway perspective view, the pipe bus according to one embodiment of the present invention

FIG. 3 is, in perspective view, a bar clamp of the apparatus according to the present invention.

### DETAILED DESCRIPTION OF EMBODIMENTS OF THE INVENTION

The tool according to one aspect of the present invention may be described as a “pipe bus bypass jumper” tool. The tool is mounted to the switch rack, that is the platform upon which the switch insulators and load carrying apparatus are mounted. This tool is intended to be used in conjunction with so-called Bare-Hand work methods known in the art. The tool is used in a work procedure which allows the operating mechanism of one phase of a switch to be taken out of service without interruption of electrical current flow.

Current practice is to use wire jumpers across the length of the switch, and tie-wrap the conductor to an insulated hot line tool. This hot line tool is used to hold the jumpers rigid, and helps control the jumpers when lowered into position. The jumpers are then attached on either side of the switch to complete the electrical connection. Upon completion of this connection, the jumpers must be secured to the switch in a way that does not allow the switch to be opened.

The tool is mounted to the switch rack 10 alongside switch 10a (shown diagrammatically in dotted outline) and in particular alongside the operating mechanism of the affected switch pole. The energized load carrying portion 12 of the tool is mounted over switch 10a using vertically oriented station-class polymer insulators 14. Insulators 14 serve to both hold the pipe bus 12 in place, and to insulate the pipe bus from ground potential. With the tool mounted in this fashion, it does not obstruct the operating portion of the switch. This allows the switch to be opened, and repaired, without affecting electrical load passing through the switch location.

Ultimately, three of these tools may be used to bypass an entire three pole switch, for example a 345 kV switch. One tool is applied to each phase in succession, with the final result being all three poles are bypassed. The switch may then be opened and repaired with the full load being carried by the bypass tools.

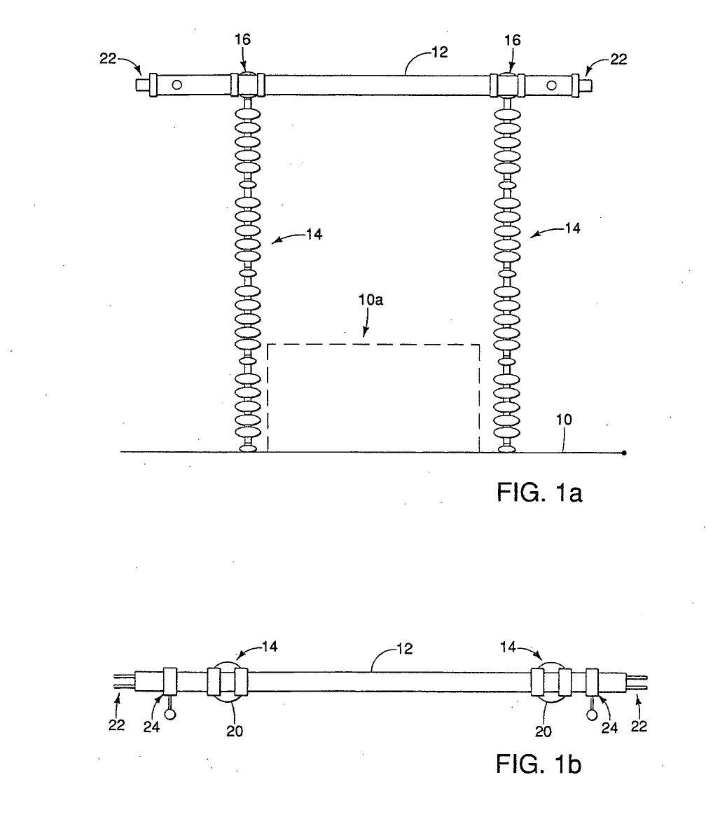

As seen in FIGS. 1a and 1b, a 5 inch diameter aluminum bus 12 which may for example be 16 feet long, is provided and electrically connected so as to extend between wire jumpers (not shown) which are attached to each of the opposite ends of bus 12. The wire jumpers are electrically connected to the permanent switch jumper material (also not shown). Station—class polymer insulators 14 are mounted to bus 12, for example, in spaced apart parallel array extending orthogonally from bus 12. Insulators 12 serve to hold the pipe in bus 12 rigidly in place over the switch 10a, with sufficient clearance as described above, and also to insulate the pipe bus 12 from the ground potential.

Insulators 14 may be mounted in one embodiment to pipe bus 12 by means of upper and lower concave clamps 16a and 16b. Each of the concave half clamps 16a and 16b are rigidly clamped on opposite sides by fasteners for example studs 18a secured by nuts 18b. Insulator adaptors 20 may be mounted between for example upper clamps 16a and their corresponding insulators 14.

Standard four-bolt ends 22 may be mounted on the opposite ends of pipe bus 12. Releasable collars 24 may also be mounted on opposite ends of bus 12.

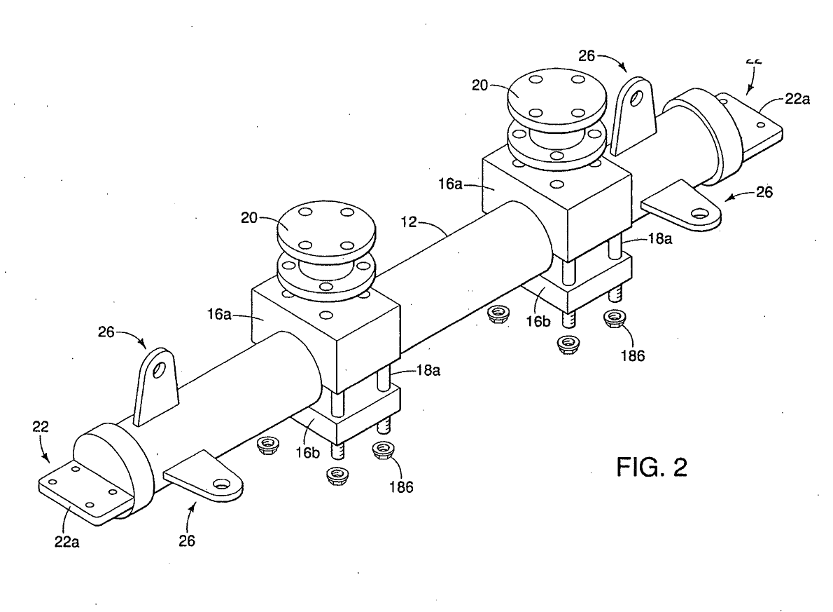

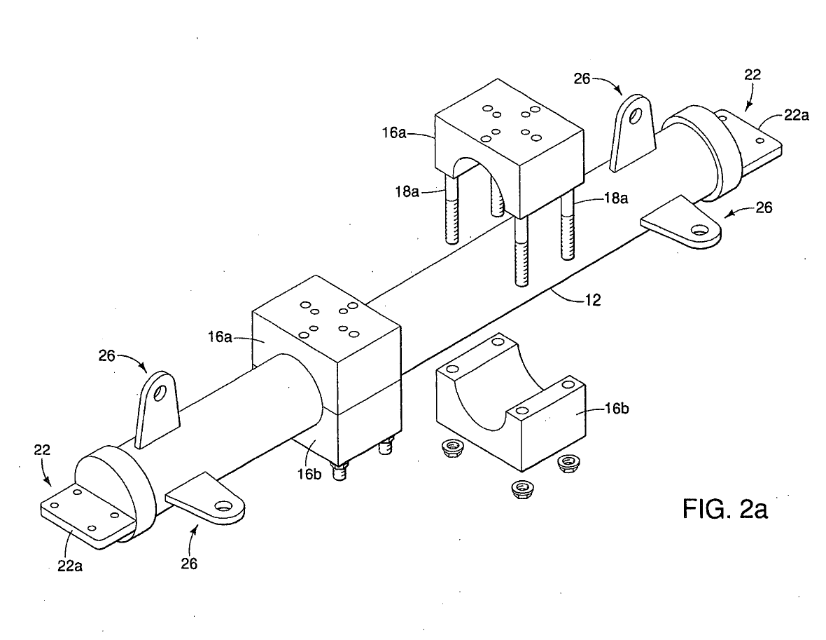

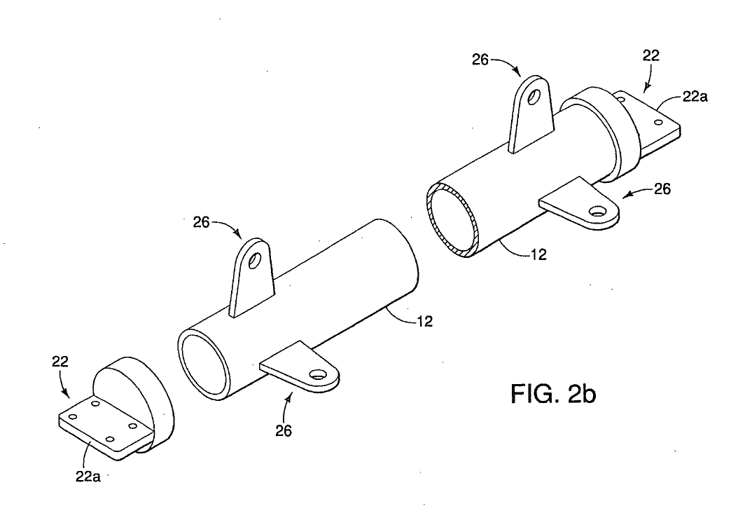

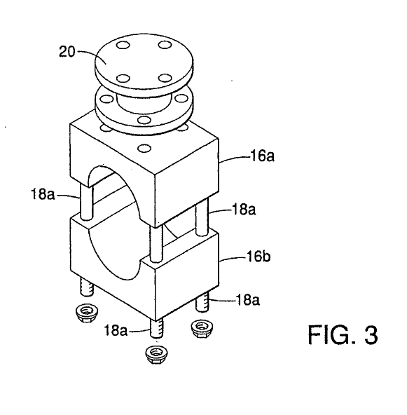

In the further embodiment of FIG. 2, lifting vangs 26 may be rigidly mounted to the opposite ends of pipe bus 12. In one embodiment each end of pipe bus 12 is provided with at least two, readily spaced apart, lifting vangs 26, for example, with one set of lifting vangs 26 parallel to the plane of the bolt ends 22 on end caps 22, and a second set of lifting vangs positioned at 45 degrees offset from the first set of lifting vangs.

In one embodiment, pipe bus 12 is for example made of 6061T-6 aluminum. It will be understood by those skilled in the art that pipe buses of other dimensions and other conductive material will also work.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An apparatus for bypassing a switch comprising:
a pipe bus,
rigid, elongate first and second insulators mounted to said pipe bus,
wherein said first and second insulators are spaced apart by a first spacing, and are both mounted at upper ends thereof to said bus so as to depend downwardly from said bus,
said first and second insulators mountable at lower ends thereof to a switch rack having a switch mounted thereon,
said first and second insulators elevating said bus above the switch rack by a second spacing when said lower ends of said insulators are mounted to the switch rack,
wherein said first and second spacings define a switch receiving aperture whereby said bus and said first and second insulators are mountable over and on opposite sides of the switch respectively, and wherein the first and second spacings are sized to provide space between the switch and said bus or said insulators so that an operating portion of the switch is not obstructed by said bus or said insulators.

2. The apparatus of claim 1 wherein said first and second insulators are a substantially parallel pair of insulators.

3. The apparatus of claim 2 wherein said bus is metallic.

4. The apparatus of claim 3 wherein said bus is aluminium.

5. The apparatus of claim 3 wherein said bus is substantially five inches in diameter.

6. The apparatus of claim 2 wherein said bus is at least substantially 15 feet long.

7. The apparatus of claim 1 wherein said insulators are mounted at opposite end of said bus.

8. The apparatus of claim 7 wherein said insulators are substantially parallel.

9. The apparatus of claim 8 wherein said insulators are station—class polymer insulators.

10. A method for bypassing an energized switch comprising the steps of:
a) providing a pipe bus,
b) providing rigid, elongate first and second insulators and mounting said insulators to said pipe bus,
c) spacing said first and second insulators apart by a first spacing, and mounting said insulators at upper ends thereof to said bus so as to downwardly depend from said bus,
d) mounting lower ends of said insulators to a switch rack having a switch mounted thereon so as to position the switch between said insulators, and so as to elevate said bus above the switch,
e) sizing spacing between the switch and said bus and said insulators so that an operating portion of the switch is not obstructed by said bus or said insulators during operation of the switch.

11. The method of claim 10 further comprising the step of aligning said insulators so that they are substantially parallel and downwardly orthogonally depending from said bus.

12. The method of claim 11 further comprising mounting said insulators at opposite ends of said bus.
